(19) United States
(12) Patent Application Publication
(10) Pub. No.: US 2026/0241417 A1
(43) Pub. Date: Aug. 20, 2026

(54) APPARATUS FOR AN AUTOMATIC SORTING MACHINE, SORTING MACHINE AND METHOD

(71) Applicant: TOMRA SORTING GMBH, Mülheim-Kärlich (DE)

(72) Inventors: Dirk BALTHASAR, Boppard (DE); Volkmar KOBELT, Mülheim-Kärlich (DE)

(73) Assignee: TOMRA SORTING GMBH, Mülheim-Kärlich (DE)

(21) Appl. No.: 19/489,615

(22) PCT Filed: Jun. 7, 2024
(86) PCT No.: PCT/EP2024/065714

§ 371 Date: Dec. 3, 2025

(30) Foreign Application Priority Data
Jun. 7, 2023 (EP) 23178066.9
Jul. 24, 2023 (SE) 2350909-4

(51) Int. Cl. B07C 5/342

(52) U.S. Cl. CPC B07C 5/3425; B07C 2501/0018; B07C 2501/0036; B07C 2501/0054

(57) ABSTRACT

An apparatus for an automatic sorting machine, which apparatus allows the automatic sorting machine to sort matter to a target specification, the apparatus including: a sensor device adapted to capture a reading of a matter passing the sensor device; and at least one processing device configured to: receive a first classifier defining an acceptable range of a property of the matter to meet said target specification; receive at least one second classifier defining a possibly acceptable range; detect said property of said matter based on said captured reading; and determine whether the detected property falls within the acceptable range of the first classifier, within the possibly acceptable range of the at least one second classifier, or outside the ranges of the first and second classifiers.

### TECHNICAL FIELD

The present disclosure relates to an apparatus for an automatic sorting machine. The present disclosure also relates to an automatic sorting machine comprising such an apparatus. The present disclosure also relates to a method for sorting matter to a target specification.

### BACKGROUND

Automatic sorting machines may be used for waste sorting for recycling purposes. Automatic sorting machines may for example used for sorting plastic waste or metal waste, such as a stream of plastic or metal flakes or chips.

An exemplary automatic sorting machine for flakes may comprise a hopper for receiving matter/flakes to be sorted, a scanner box for material and color detection, an electromagnetic sensor for metal detection, air ejection means with valves and nozzles, and a separation chamber. Clear/light blue (PET) flakes are accepted, whereas impurities (colored flakes, non-PET flakes, and metals) are ejected. Rejected flakes may be scanned for a second time.

EP 2 832 458 provides an optical type granule sorting machine which allows a sensitivity setting to be performed by utilizing RGB three-dimensional color space information similar to information obtained via human eyes. Data is created on wavelength components of R light, G light, and B light from the granules, on a three-dimensional color space. A creation section sets an interface calculated based on a Mahalanobis distance to partition the data into a conforming-granule cluster area and a nonconforming granule cluster area. A Euclidean distance interface creation section determines a position of center of gravity of the conforming granule cluster area and a position of center of gravity of the nonconforming granule cluster area to set an interface calculated based on a Euclidean distance at which the positions of center of gravity lie at a longest distance from each other. A threshold determination section that determines a line of intersection between the interface calculated based on the Mahalanobis distance and the interface calculated based on the Euclidean distance, to determine the line of intersection to be a determination threshold that allows determination of whether or not the granules are to be treated as a separation target.

### SUMMARY

It is therefore an object of the present disclosure to provide an improved apparatus which allows an automatic sorting machine to sort matter to a target specification, for example a target color or a target recipe for an alloy.

To achieve the above object, and also other objects that will be evident from the following description, an apparatus having the features defined in claim 1 is provided according to the present disclosure. Preferred variants of the apparatus will be evident from the dependent claims.

More specifically, according to a first aspect there is provided an apparatus for an automatic sorting machine, which apparatus allows the automatic sorting machine to sort matter to a target specification, the apparatus comprising: a sensor device adapted to capture a reading of a matter passing the sensor device; and at least one processing device configured to:
a) receive a first input of a first classifier defining an acceptable range of a property of the matter to meet said target specification;
b) receive a second input of at least one second classifier defining a possibly acceptable range of said property to meet said target specification;
c) detect said property of said matter based on said captured reading;
d) determine whether the detected property falls within the acceptable range of the first classifier, within the possibly acceptable range of the at least one second classifier, or outside the ranges of the first and second classifiers;
e) cause the matter to be accepted by the automatic sorting machine if the detected property falls within the acceptable range of the first classifier;
f) if the detected property falls within the possibly acceptable range of the at least one second classifier, cause the matter to be accepted by the automatic sorting machine if a current average of the property of sorted matter updated with the detected property falls within the acceptable range of the first classifier and cause the matter to be rejected by the automatic sorting machine if the current average of the property updated with the detected property falls outside the acceptable range of the first classifier; and
g) cause the matter to be rejected by the automatic sorting machine if the detected property falls outside the ranges of the first and second classifiers.

The present disclosure is based on the understanding that by sorting matter based on blending rules as in feature e) to g), i.e. accept matter within an acceptable range of a first classifier but also accept matter within a possibly acceptable range of at least one second classifier if the average property of sorted matter becomes acceptable (or otherwise reject the matter), less matter may be rejected and better efficiency of blending may be achieved.

The sensor device may be adapted to capture a reading of matter passing the sensor device on a conveyor belt, on a chute, or free-falling, preferably at a speed of between 0.4 m/s-20 m/s. That is, the sensor device may be adapted to capture a reading of matter passing the sensor device at a speed of between 0.4 m/s-20 m/s.

The sensor device may be adapted to (continuously) capture readings of a batch of matter passing the sensor device, and wherein the at least one processing device is configured to (continuously/repeatedly) perform c) to g) for substantially each matter of said batch. In this way, bulk sensor-based sorting to target specification may be realized.

The at least one processing device may configured to update the current average of the property of sorted matter with the detected property of the accepted matter. Specifically, the at least one processing device may be configured to update the current average of the property of sorted matter of the batch using vectors and the function:

$${v}_{b}^{′} = {v}_{b} + ( v - {v}_{b} ) r$$

wherein v′_{b} is the updated current average of the property, v_{b} is the current average of the property, v is the detected property of the accepted matter, and r is a rate in the range of 10⁻³⁰⁸ to 0.5. That is, the sorting is here based on averaging vectors. A very small r may lead to more acceptance of lesser quality material to the batch. A higher r will lead to stricter sorting. Since the batch arithmetic is here performed on vectors, no special logic for the classifiers is needed. Moreover, the execution time may be reduced.

In an embodiment, the target specification includes a target color, wherein the detected property includes the color of the matter. The target color can for example be clear/light blue.

The at least one processing device may here be configured to express the detected color as coordinates in a color circle color space, wherein the first and second classifiers are polygons in said color circle color space. Specifically, the detected color may be described using hue (H) and saturation(S) expressed by color circle coordinates. Advantages of using circular representation of HS include: in the center are all gray tones (black to white), no singularity for dark colors and unsaturated colors, no problems with visualization of hue 0° and 359°, blending math easier—no issue at 0°/359°, and circular coordinates can be converted fast with dot product. Other color spaces than the HS(V) color circle could be used as well, such as RGB, IHS, CIE L*a*b*, CIE L*u*v*, YUV, YIQ, HSV, xy, rg, HSI, HLS, YCbCr, OHTA, LCH-uv, LCH-ab, etc.

In another embodiment, the target specification includes a target alloy constitution (or ‘recipe’), wherein the detected property includes the element constitution of the matter.

The application of the disclosed approach to aluminum alloys (and the recycling thereof) can advantageously allow for less waste to be produced during a batch, and thus higher recycling rates.

Furthermore, a greater level of flexibility may be afforded to alloy recipes applied to recycling processes.

The sensor device may comprise a digital RGB (red, green, and blue) camera adapted to take an image (=“capture a reading” in claim 1) of the matter passing the digital RGB camera, wherein the detected property is the color of at least one pixel of the matter in the image. The at least one processing device may here be configured to convert RGB values of said at least one pixel to said coordinates in the color circle color space using dot product operations, preferably mean normalization dot products. This conversion from RGB values to (color circle) coordinates is fast and contributes to fast sorting of matter.

The sensor device may alternatively or in addition comprise a visual spectrometer adapted to capture visual spectral data (=“capture a reading”) of the matter, wherein the at least one processing device is configured to detect the color of the matter based on the captured visual spectral data. The at least one processing device may here be configured to first convert the visual spectral data to RGB using CIE, and then to convert the RGB to the (color circle) coordinates. Moreover, the spectrometer output could be used as a vector for the averaging without any conversions.

The sensor device may alternatively or in addition be configured for performing Laser-Induced Breakdown Spectroscopy (LIBS), which allows the alloy elements to be determined and quantified with precision thus permitting a distinction to be made between a large number of different alloy types.

The at least one processing device may further be configured to detect an intensity (g) of the matter based on the captured reading, and to cause the matter to be accepted by the automatic sorting machine if the detected property (e.g. color) falls within the acceptable range of the first classifier and the detected intensity falls within a first predetermined acceptable intensity range. The at least one processing device may further be configured to cause the matter to be accepted by the automatic sorting machine if i) the detected property falls within the possibly acceptable range of the at least one second classifier, ii) the current average of the property (of the sorted matter) updated with the detected property falls within the acceptable range of the first classifier, iii) the detected intensity falls within a second predetermined possibly acceptable intensity range, and iv) a current average of the intensity of the sorted matter updated with the detected intensity falls within the first predetermined acceptable intensity range. By also taking into account the intensity or brightness of the matter, more refined sorting may be achieved. The intensity of the matter may be detected/determined from the reading (image/visual spectral data) using dot product operations.

The first predetermined acceptable intensity range is preferably a narrower sub-range of the second predetermined possibly acceptable intensity range. In this way, the apparatus may accept more deviation, but the mix should not exceed the (narrower) first predetermined acceptable intensity range.

In another embodiment, the target specification includes a target material type, wherein the sensor device comprises a spectrometer adapted determine a spectrum (=“capture a reading”) of the matter passing the spectrometer, and wherein the detected property is material type of the matter. The target material type can for example be PET (polyethylene terephthalate), PE, PO, PVC, etc. Here, the at least one processing device may be configured to express the detected material (type) as coordinates in a scatter plot, and the first and second classifiers may be polygons in said scatter plot.

In a further embodiment, the target specification may include both a target color and a target material type, wherein the first classifier defines an acceptable range of color of the matter to meet said target specification, wherein another first classifier defines an acceptable range of material type of the matter to meet said target specification, and wherein the at least one processing device is configured to cause the matter to be accepted by the automatic sorting machine if the detected color falls within the acceptable range of said first classifier AND if the detected material type falls with the acceptable range of said another first classifier. Moreover, the at least one processing device may be configured to cause the matter to be accepted by the automatic sorting machine if i′) the detected color falls within the possibly acceptable (color) range of the at least one second classifier, ii′) the current average of the color updated with the detected color falls within the acceptable range of the first classifier, iii′) the detected material type falls within a second predetermined possibly acceptable material type range, and iv′) a current average of the material type of the sorted matter updated with the detected material type falls within the acceptable range of said another first classifier. Moreover, the at least one processing device may be configured to update (both) the current average of the color of sorted matter with the detected color of the accepted matter and the current average of the material type of sorted matter with the detected material type of the accepted matter. Moreover, a matter may also be accepted if one of the detected color and the detected material type falls within its first classifier and the other falls within its second classifier+the current average of the other as updated would fall within its first classifier. In one embodiment, if one of the detected color and the detected material type falls within its second classifier+the current average as updated would fall within its first classifier, then the other must fall within its first classifier for the matter to be accepted (i.e. in this embodiment a matter fulfilling i′) to iv′) would not be accepted). Moreover, the at least one processing device may be configured to cause the matter to be rejected by the automatic sorting machine if one (or both) of the detected color and material type fall(s) outside the respective first classifier, or if not all criteria i′) to iv′) are fulfilled. Here, the sensor device may comprise (both) the aforementioned spectrometer as well as the digital RGB camera or visual spectrometer.

Generally, the target specification may include a first property (e.g. color) and a second, different property (e.g. material type), wherein the first classifier defines an acceptable range of the first property of the matter to meet said target specification, wherein another first classifier defines an acceptable range of the second property of the matter to meet said target specification, wherein the at least one processing device is configured to detect said first and second properties of said matter based on said captured reading and optionally/possibly on at least one other reading of the matter captured by the sensor device (e.g. digital RGB camera+spectrometer), and to cause the matter to be accepted by the automatic sorting machine if the detected first property falls within the acceptable range of said first classifier AND if the detected second property falls with the acceptable range of said another first classifier.

According to a second aspect of the present disclosure there is provided an automatic sorting machine adapted to sort matter to a target specification, the automatic sorting machine comprising: an apparatus according to the first aspect; means for providing a stream of matter past the sensor device of said apparatus; a container adapted to receive accepted matter from said stream; and an ejector adapted to remove rejected matter from said stream before reaching said container. The means for providing a stream of matter past the sensor device comprises at least one of: a conveyor belt, a chute, and a free-falling arrangement. Said means may be configured to operate at a speed of between 0.4 m/s-20 m/s.

According to a third aspect of the present disclosure there is provided a method for sorting matter to a target specification, the method comprising: receiving (e.g. from a user interface) a first input of a first classifier defining an acceptable range of a property of the matter to meet said target specification; receiving (e.g. from the user interface) a second input of at least one second classifier defining a possibly acceptable range of said property to meet said target specification; capturing, by a sensor device, a reading of a matter passing the sensor device; detecting said property of said matter based on said captured reading; determining, by at least one processing device, whether the detected property falls within the acceptable range of the first classifier, within the possibly acceptable range of the at least one second classifier, or outside the ranges of the first and second classifiers; causing the matter to be accepted by an automatic sorting machine if the detected property falls within the acceptable range of the first classifier; if the detected property falls within the possibly acceptable range of the at least one second classifier, causing the matter to be accepted by the automatic sorting machine if a current average of the property of sorted matter updated with the detected property falls within the acceptable range of the first classifier and causing the matter to be rejected by the automatic sorting machine if the current average of the property updated with the detected property falls outside the acceptable range of the first classifier; and causing the matter to be rejected by the automatic sorting machine if the detected property falls outside the ranges of the first and second classifiers. This aspect may exhibit the same or similar features and technical effects as the first and/or second aspects, and vice versa.

The matter may be or include at least one plastic flake, such as PET flake, PE flake, PO flake, and/or PVC flake.

Moreover, causing the matter to be accepted by the automatic sorting machine may include refraining from sending an ejection signal to an ejector of the automatic sorting machine for the matter, whereby the matter is received in a first container of the automatic sorting machine. Moreover, causing the matter to be rejected by the automatic sorting machine may include sending an ejection signal to the ejector for the matter. Here, the method could further comprise the ejector ejecting the matter based on the ejection signal, whereby the matter is received in a second container of the automatic sorting machine.

### BRIEF DESCRIPTION OF THE DRAWINGS

One or more embodiments of the present disclosure will be described, by way of example only, and with reference to the following figures, in which:

FIG. 1 is a schematic side view of an apparatus according to an aspect of the present disclosure;

FIG. 2 is a schematic side view of an automatic sorting machine according to another aspect of the present disclosure;

FIG. 3 is a flowchart of a method according to yet another aspect of the present disclosure;

FIG. 4 illustrates classifiers in a color circle color space;

FIG. 5 illustrates an exemplary GUI for inputting classifiers;

FIG. 6 is a flowchart of a variant of the method of FIG. 3;

FIG. 7 illustrates predetermined intensity ranges; and

FIG. 8 illustrates material type classifiers in a scatterplot.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

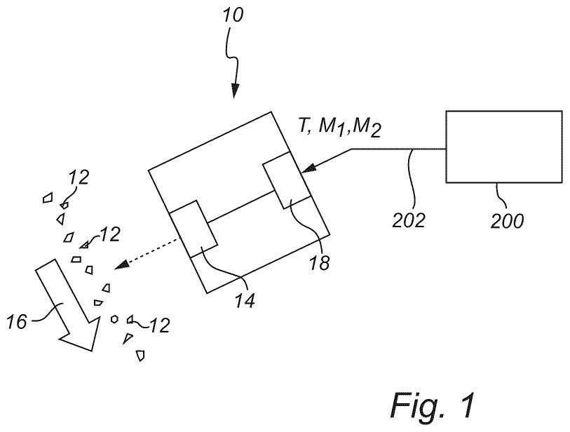

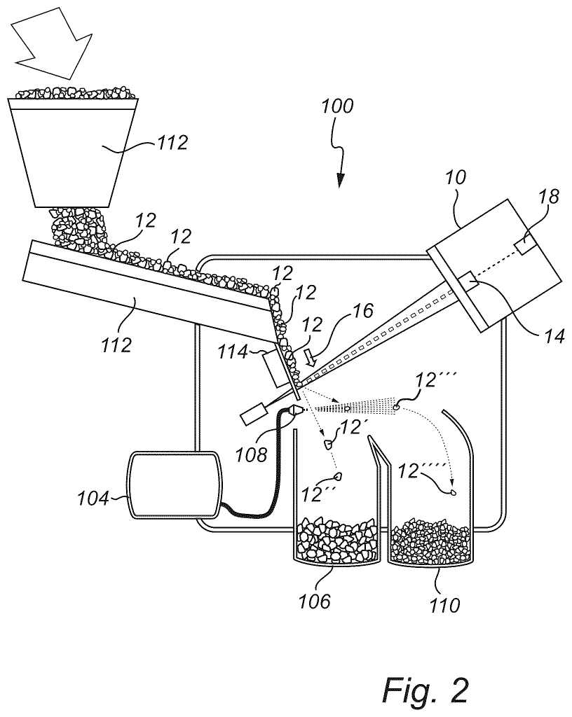

FIG. 1 illustrates an apparatus 10 for an automatic sorting machine 100 (see FIG. 2). As such, the apparatus 10 may be included in the automatic sorting machine 100. The apparatus 10 is generally adapted to allow the automatic sorting machine 100 to sort matter 12 to a target specification, for example a target color such as clear/light blue. That is, the apparatus 10 should allow the automatic sorting machine 100 to accept/collect only matter 12′ contributing to meet the target specification, whereas any matter 12′″ also coming into the machine 100 but not contributing to the target specification is rejected/ejected. The matter 12 may for example include plastic flakes of different colors, typically from recycling of packaging/containers such as PET bottles.

The apparatus 10 comprises a sensor device 14. The sensor device 14 is adapted to capture a reading of matter 12 passing the sensor device 14. The sensor device 14 may for example comprise a digital RGB camera adapted to take a digital image (e.g. a video frame) of the matter 12 passing the digital RGB camera, or a visual spectrometer adapted to capture visual spectral data of the matter 12 passing the sensor device 14.

The matter 12 passing the sensor device 14 may form a stream of matter 12, as indicated by arrow 16. To this end, the digital RGB camera or visual spectrometer of the sensor device 14 may be aimed towards the stream of matter 12. The stream of matter 12 past the sensor device 14 may for example be provided by a conveyor belt or chute 102 of the automatic sorting machine 100, please see FIG. 2. In operation, the (stream of) matter 12 may pass the sensor device 14 at a speed of between 0.4 m/s-20 m/s, for example.

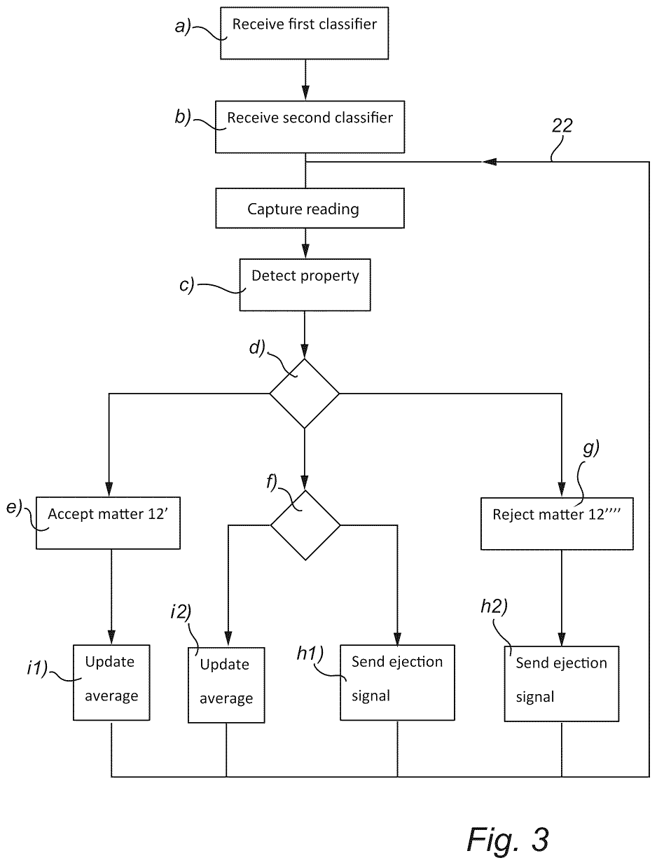

The apparatus 10 further comprises at least one processing device 18. The at least one processing device 18 may be connected to the aforementioned digital RGB camera or visual spectrometer. The at least one processing device 18 may for example include circuitry/a processor (CPU), in particular a processor (CPU) of a computer (of the apparatus 10). The at least one processing device 18 is configured (e.g. by software) to perform various tasks or steps as will be explained in the following with further reference to FIG. 3. FIG. 3 illustrates a method, which may correspond to operation of the apparatus 10.

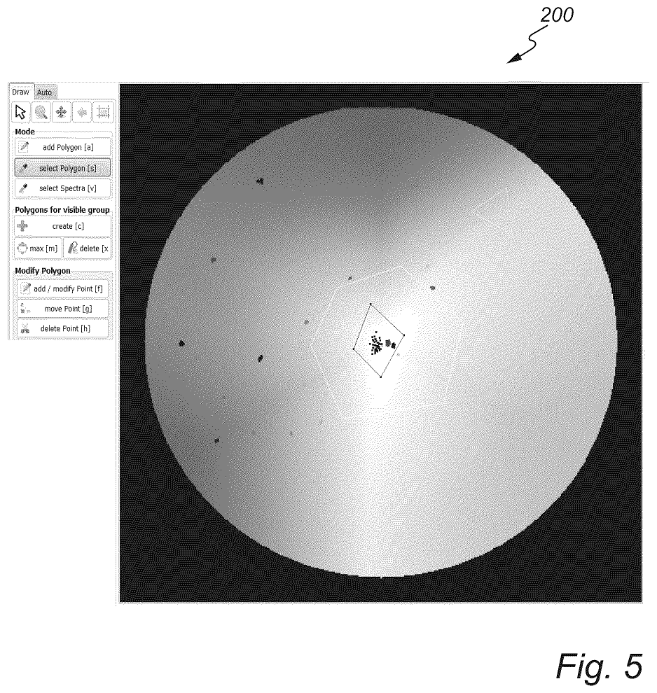

At a), the at least one processing device 18 receives a first input of a first classifier T. The first input of the first classifier T may be received from a user interface, for example graphical user interface (GUI) 200 shown in FIG. 5. The user interface 200 will typically be remote from the apparatus 10, and connected to the apparatus 10 via a wire or wireless connection 202. Furthermore, the first classifier T will typically be input by a human operator via the user interface 200.

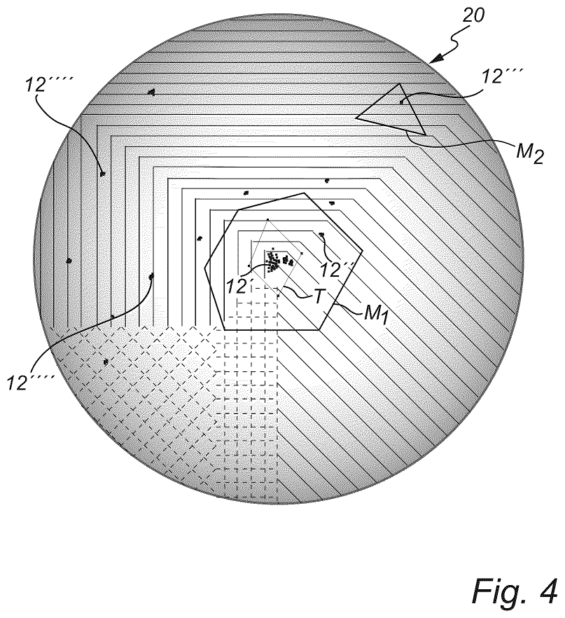

The first classifier T defines an acceptable range of a property of the matter 12 to meet the target specification. In case the target specification is target color, the first classifier T may define an acceptable color range. As will be described further hereinbelow, the first classifier T may for example be a closed figure, namely a polygon, in a color circle color space 20, please see FIGS. 4-5. If the target color is clear/light blue, the first classifier T may be a polygon at the center of the color circle color space 20, as in FIGS. 4-5. In FIG. 4, the different patterns schematically indicate different colors in the color circle color space 20.

At b), the at least one processing device 18 receives a second input of at least one second classifier M₁, M₂. The first second input of the at least one second classifier M₁, M₂ may be received from the user interface 200. The at least one second classifier M₁, M₂ will typically be input by the human operator via the user interface 200.

Alternatively, the classifiers such as T and M₁, M₂ may be set automatically by recording training sets and adapting the classifiers automatically using supervised learning.

The at least one second classifier M₁, M₂ defines a possibly acceptable range of the property of the matter 12 to meet the target specification. In case the target specification is target color, the at least one second classifier M₁, M₂ may define a possibly acceptable color range, which also may be referred to as acceptable mixing candidate colors. The at least one second classifier M₁, M₂ may for example be one or more closed figures, namely at least one polygon, in the color circle color space 20. If the target color is clear/light blue, second classifier M₁ may be a polygon e.g. surrounding the (smaller) first classifier T at the center of the color circle color space 20 and second classifier M₂ may be a polygon placed at an area of the color circle color space 20 with blue colors, as in FIGS. 4-5. Accordingly, the first classifier T may be referred to as a strict classifier, whereas the at least one second classifier M₁, M₂ may be referred to as at least one relaxed classifier.

It should be noted that b) could be performed before, after, or at the same time as a).

At c), the at least one processing device 18 detects the property in question (e.g. color) of an individual matter 12 (e.g. a plastic flake) based on the reading captured by the sensor device 14. In case the target specification is target color, the detected color of the matter 12 may be expressed as (color circle) coordinates in the color circle color space 20. Specifically, the detected color may be described using hue (H) and saturation(S) expressed by the color circle coordinates.

Where the sensor device 14 comprises the digital RGB camera, the detected property may be the color of at least one pixel of the matter 12 in the image taken by the digital RGB camera, and the at least one processing device 18 may convert RGB values of the at least one pixel to corresponding (color circle) coordinates in the color circle color space 20 using dot product operations (color circle), preferably mean normalization dot products. Expressed as vector notation, the conversion from RGB values to color circle coordinates (cₓ, c_{y}) may be:

$$( \begin{matrix}a \\ b\end{matrix} ) = ( \begin{matrix}sin ( 0 ) & sin ( \frac{2}{3} π ) & sin ( \frac{4}{3} π ) \\ cos ( 0 ) & cos ( \frac{2}{3} π ) & cos ( \frac{4}{3} π )\end{matrix} ) ( \begin{matrix}R \\ G \\ B\end{matrix} )$$

$$( \begin{matrix}{c}_{x} \\ {c}_{y}\end{matrix} ) = \frac{S}{\sqrt{{a}^{2} + {b}^{2}}} ( \begin{matrix}a \\ b\end{matrix} )$$

When R,G,B is mean normalized, the scaling is not required. So for mean normalized RGB values, the following conversion may be used:

$$( \begin{matrix}{c}_{x} \\ {c}_{y}\end{matrix} ) = ( \begin{matrix}cos ( 0 ) & cos ( \frac{2}{3} π ) & cos ( \frac{4}{3} π ) \\ sin ( 0 ) & sin ( \frac{2}{3} π ) & sin ( \frac{4}{3} π )\end{matrix} ) {( \begin{matrix}R \\ G \\ B\end{matrix} )}_{μ}$$

where μ is mean normalized RGB (r/av g/av b/av); av=(R+G+B)/3.

Where the sensor device 14 comprises the visual spectrometer, the at least one processing device 18 may detect the color of the matter 12 based on the captured visual spectral data. The at least one processing device 18 may here be configured to first convert the visual spectral data to RGB using CIE (step 1), and then to convert the RGB to the color circle coordinates (step 2).

In step 1, CIE matching functions (fr,fg,fb) from e.g. table from “Color Science” by Wyszecki & Stiles (1982) p. 750 can be used to calculate the typical RGB stimulus for a human observer. If the visual spectrometer is clipped in the blue channels, a white balance may be used for natural image, otherwise blue could be underrepresented. Score vectors may then be adapted to fit into a range of 0 . . . 255.

In step 2, the above-mentioned conversion from RGB to color circle coordinates is used by replacing R,G,B by fᵣ, f_{g}, f_{b}. The vector data should be mean normalized:

$$( \begin{matrix}{c}_{x} \\ {c}_{y}\end{matrix} ) = ( \begin{matrix}cos ( 0 ) & cos ( \frac{2}{3} π ) & cos ( \frac{4}{3} π ) \\ sin ( 0 ) & sin ( \frac{2}{3} π ) & sin ( \frac{4}{3} π )\end{matrix} ) ( \begin{matrix}{f}_{r} \\ {f}_{g} \\ {f}_{b}\end{matrix} ) {v}_{μ}^{T}$$

wherein v_{μ}^{T} is the mean normalized spectrum.

Matrix multiplication leads to the following calculation with two score vectors Sₓ, S_{y}:

$$( \begin{matrix}{c}_{x} \\ {c}_{y}\end{matrix} ) = ( \begin{matrix}{S}_{x} \\ {S}_{y}\end{matrix} ) {v}_{μ}^{T}$$

At d), the at least one processing device 18 determines whether the detected property falls:
within the acceptable range of the first classifier T (for example, the detected color cₓ, c_{y} of the matter is inside the first classifier/polygon T),
within the possibly acceptable range of the at least one second classifier (for example, the detected color cₓ, c_{y} of the matter is inside any of the second classifiers/polygons M₁, M₂), or
outside the ranges of the first and second classifiers (for example, the detected color cₓ, c_{y} of the matter is outside the first and second classifiers/polygons T, M₁, and M₂).

If the detected property falls within the acceptable range of the first classifier, e.g. (cₓ, c_{y}) E T, the at least one processing device 18 may cause the individual matter now designated 12′ to be accepted by the automatic sorting machine 100 at e). To do this, the at least one processing device 18 may refrain from sending an ejection signal to an ejector 104 of the automatic sorting machine 100 for this matter 12′, so that it is not removed from the stream 16 but instead received in a container 106 of the automatic sorting machine 100.

If the detected property falls within the possibly acceptable range of the at least one second classifier, e.g. (cₓ, c_{y})∈M₁ or (cₓ, c_{y})∈M₂, the at least one processing device 18 may cause the individual matter now designated 12″ to be accepted by the automatic sorting machine 100 at f) if also a current average of the property of already sorted (accepted) matter of a batch B of matter updated with the detected property of the individual matter 12″ falls within the acceptable range of the first classifier T (e.g. (cₓ′, c_{y}′)∈T), wherein the update may be:

$$( {c}_{x}^{′} , {c}_{y}^{′} ) = average ( ( B ⋃ ( {c}_{x} , {c}_{y} ) ) .$$

In other words, the vector cₓ, c_{y} needs to fit to already seen colors in the batch B. As such, the acceptable range of the first classifier T may also be referred to as acceptable average color.

On the other hand, if the current average of the property updated with the detected property falls outside the acceptable range of the first classifier T, e.g. (cₓ′, c_{y}′)∉T, the at least one processing device 18 may cause the matter to be rejected by the automatic sorting machine 100. To do this, the at least one processing device 18 may at h1) send an ejection signal to the ejector 104 for this matter now designated 12″, so that it is removed from the stream 16 and not received in the container 106 (but in additional container 110).

If the detected property falls outside the ranges of the first and second classifiers T, M₁, and M₂, the at least one processing device 18 may cause the individual matter now designated 12″″ to be rejected by the automatic sorting machine 100. To do this, the at least one processing device 18 may at h2) send an ejection signal to the ejector 104 for this matter 12″″, so that it is removed from the stream 16 and not received in the container 106.

By sorting matter based on blending rules as in feature e) to g), i.e. accept matter within an acceptable range of the first classifier T but also accept matter within a possibly acceptable range of the at least one second classifier M₁, M₂ if the average property of sorted matter becomes acceptable (or otherwise reject the matter), less matter may be rejected and better efficiency of blending may be achieved.

When a matter 12′ or 12″ is accepted at e) or f), the at least one processing device 18 may update the current average of the property of sorted matter of the batch B with the detected property of the accepted matter 12′ or 12″ at i1) or i2), respectively. This update may generally be defined as: B′=B∪(cₓ, c_{y}). Specifically, the current average of the property of sorted matter of the batch may be updated by the at least one processing device 18 using the function:

$${v}_{b}^{′} = {v}_{b} + ( v - {v}_{b} ) r$$

wherein v′_{b} is the updated current average of the property, v_{b} is the current average of the property, v is the detected property of the accepted matter, and r is a rate, preferably in the range of 10⁻³⁰⁸ to 0.5. A very small r may lead to more acceptance of lesser quality material to the batch. A higher r will lead to stricter sorting.

An alternative update function leading to higher penalty depended on vector distance to center is:

$${v}_{b}^{′} = {v}_{b} + ( v - {v}_{b} ) r {\vert v - {v}_{b} \vert}^{γ}$$

wherein |v−v_{b}| is the vector distance, and wherein the additional parameter y can be used to adjust the penalty. That is, γ can control the impact of the vector distance, and a high γ will lead to higher impact of the vector to the average.

The at least one processing device 18 may be configured to perform c) to g) (and h1), h2), i1), i2)), as applicable, for substantially each matter of the aforementioned batch, as indicated by arrow 22 in FIG. 3 (although parallel processing is envisaged). Furthermore, the initial start value of the current average of the property of sorted matter for a batch may be a predefined start value (vector case). Furthermore, the current average of the property of sorted matter may be reset to the predefined start value, for example on start-up, after a break, on user request, etc.

As indicated above, the automatic sorting machine 100 of FIG. 2 comprises the apparatus 10 including the sensor device 14 and the at least one processing device 18, a conveyor belt or chute 102 for providing the stream 16 of matter 12 past the sensor device 14 and towards the container 106, the container 106 adapted to receive accepted matter 12′, 12″ from the stream 16, and the ejector 104 adapted to remove rejected matter 12′″, 12″″ from the stream 16 before reaching the container 106.

The conveyor belt or chute 102 may be configured to operate at a speed of between 0.4 m/s-20 m/s.

The ejector 104 may be connected to the at least one processing device 18/apparatus 10 to receive the aforementioned ejection signal(s). The ejector 104 may comprise a plurality of air nozzles 108 distributed along the width of the conveyor belt or chute 102 for blowing the rejected matter 12′″, 12″″ away from the stream 16 (air ejection), preferably into an additional container 110 of the automatic sorting machine 100. The containers 106, 110 may be referred to as first and second containers and/or as a separation chamber.

The automatic sorting machine 100 may also comprise at least one hopper 112 for feeding matter 12 to the conveyor belt or chute 102. The automatic sorting machine 100 could also comprise an electromagnetic sensor 114 for metal detection, allowing any metal in the stream 16 to be removed by the ejector 104.

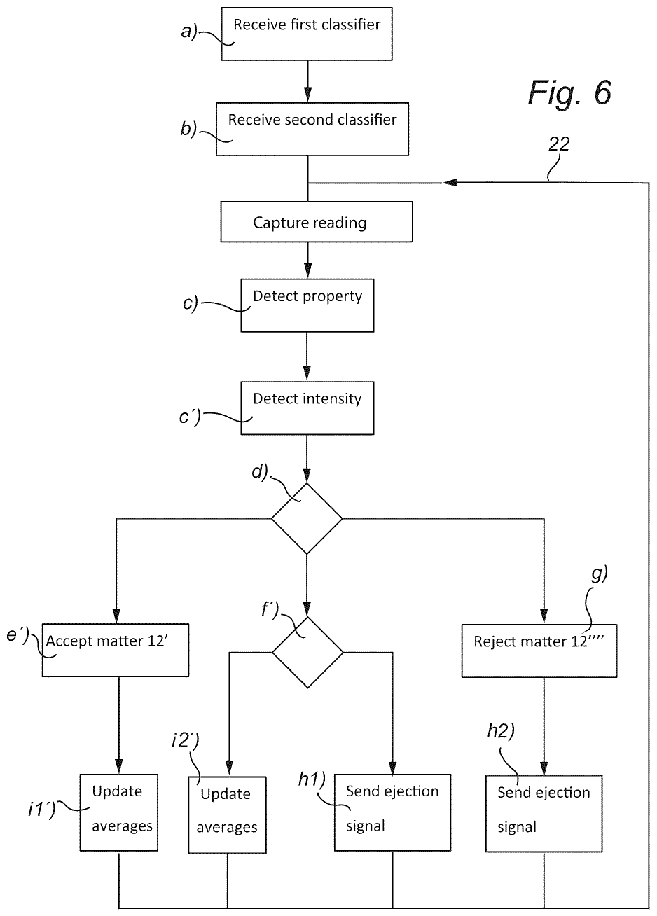

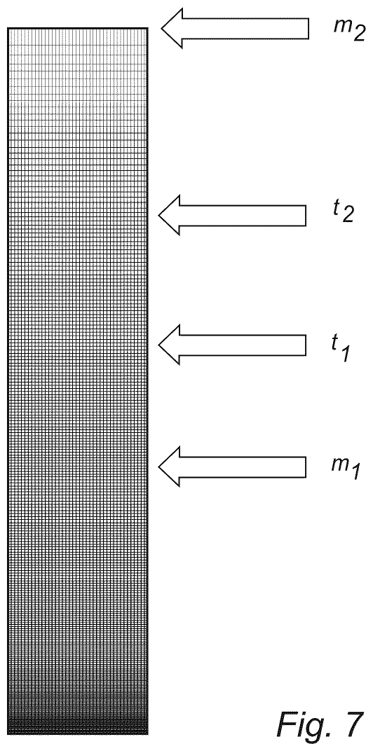

Turning to FIGS. 6-7, the method of FIG. 6 is similar to that of FIG. 3, but further includes the least one processing device 18 of the apparatus 10 detecting the intensity g of the individual matter 12 based on the captured reading, at c′).

The intensity of the matter may be detected/determined from the reading (image from the RGB camera/visual spectral data from the spectrometer) using dot product operations. The intensity may be defined by:

$$g = ( \frac{1}{n} , \frac{1}{n} , … , \frac{1}{n} )$$

wherein n is the number of channels. So for RGB, the intensity may be defined by:

$$g = ( \frac{1}{\text{?}} , \frac{1}{\text{?}} , \frac{1}{\text{?}} ) ( \begin{matrix}R \\ \text{?} \\ B\end{matrix} )$$

$$\text{?} \text{indicates text missing or illegible when filed}$$

For the visual spectrometer (16 channels), the intensity may be defined by:

$$g = ( \frac{1}{16} , … , \frac{1}{16} \} {g}^{T}$$

At e′), the at least one processing device 18 causes the individual matter 12′ to be accepted by the automatic sorting machine 100 if the detected property (e.g. color) of the matter falls within the acceptable range of the first classifier T (as in FIG. 3) and the detected intensity in c′) falls within a first predetermined acceptable intensity range t1-t2, e.g. (cₓ, c_{y}) E T AND t1≤v≤t2. The first predetermined acceptable intensity range t1-t2 may for example be set by the operator using the user interface 200, or be set automatically by recording training sets and adapting the classifier automatically using supervised learning. The first predetermined acceptable intensity range t1-t2 may for example be 100-200*. * The digital RGB camera typically (for 8-bits) has a range of 0-255.

At f′), the at least one processing device 18 may cause the individual matter 12″ to be accepted by the automatic sorting 10 machine if i) the detected property (e.g. color) falls within the possibly acceptable range of the at least one second classifier T (as in FIG. 3), ii) the current average of the property updated with the detected property falls within the acceptable range of the first classifier T (as in FIG. 3), iii) the detected intensity falls within a second predetermined possibly acceptable intensity range m1-m2 (m1≤g≤m2), and iv) a current average of the intensity of already sorted (accepted) matter of the batch B of matter 12 updated with the detected intensity of the individual matter 12′ falls within the first predetermined acceptable intensity range t1-t2 (t1≤g′≤t2). The update may here be:

$$( {c}_{x}^{′} , {c}_{y}^{′} , {g}^{′} ) = average ( ( B ⋃ ( {c}_{x} , {c}_{y} , g ) )$$

The second predetermined possibly acceptable intensity range m1-m2 may for example be set by the operator using the user interface 200. The second predetermined possibly acceptable intensity range m1-m2 may for example be 50-250*. Accordingly, the first predetermined acceptable intensity range t1-t2 may be a narrower sub-range of the second predetermined possibly acceptable intensity range m1-m2, as seen in FIG. 7.

If not all criteria i) to iv) are fulfilled, the at least one processing device 18 may cause the matter to be rejected by the automatic sorting machine 100 e.g. by sending an ejection signal at h1).

When a matter 12′ or 12″ is accepted at e′) or f′), the at least one processing device 18 may update as well the current average intensity of sorted matter of the batch B with the detected intensity of the accepted matter 12′ or 12″ at i1′) or i2′), respectively: B′=B∪(cₓ, c_{y}, g).

A matter may also be accepted if one of the detected property (e.g. color) and the detected intensity falls within its first classifier and the other falls within its second classifier+the current average of the other as updated would fall within its first classifier. Moreover, in one embodiment, if one of the detected property and the detected intensity falls within its second classifier+the current average as updated would fall within its first classifier, then the other must fall within its first classifier for the matter to be accepted (i.e. in this embodiment a matter fulfilling i) to iv) would not be accepted).

By also taking into account the intensity or brightness of the matter 12, a more refined sorting may be achieved.

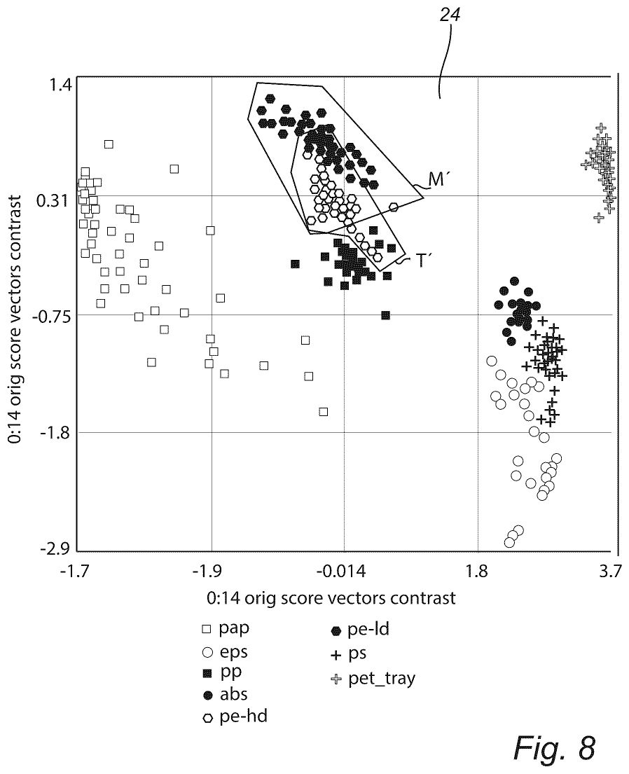

With reference to FIG. 8, in another embodiment, instead of color, the target specification may be target material (type), wherein the sensor device 14 would comprises a spectrometer adapted determine a spectrum of the matter 12 passing the spectrometer, and wherein the detected property is material type of the matter. The target material type could for example be PET, PE, PO, PVC, etc. Here, the at least one processing device 18 may be configured to express the detected material type as coordinates (i.e. a point) in a scatter plot 24, wherein the first and second classifiers T′, M′ are polygons in said scatter plot 24. Specifically, spectral data including the spectrum of the matter 12 may be normalized using SNV (Standard Normal Variate), and a PCA (Principal Component Analysis) may be performed, and the spectral data may be projected into the scatterplot 24 by using the first and second principal axis. In the particular example show in FIG. 8, T′ is the first classifier for sorting PE-HD (Polyethylene High Density), and M′ is the second classifier for possibly accepting also PE-LD (Polyethylene Low Density).

In another example, the stream of matter may be analyzed, e.g., using LIBS, to determine its composition, and the composition may be compared to a target composition or ‘recipe’ for an alloy (e.g., an aluminum alloy).

The second classifier in this example may be defined by a fixed maximum acceptable contamination level for each element, and/or an adaptive acceptable contamination level for each element, taking into account input stream composition over time and maturity of batch.

For example, in a start phase, only a fixed maximum may be sued, and within the batch, a moderate level of contamination may be accepted. At the end of the batch, it may be filled with everything to the limit of the recipe. Similar strategies for maximizing mass within recipe from input stream may be used, depending on the implementation.

A LIBS measurement is performed on a very small area, therefore different strategies can be applied to represent the batch. Batch and particles might be represented by: single measurement points (only at measuring position), measurement points multiplied by the area of the particle, and/or measurement points multiplied by the weight (volume+density) of the particle, with optionally applied heuristic correction factors to the measurement.

Adding particle to a batch may comprise spectrally accumulating the batch to average the LIBS spectrum, and accumulating an element composition vector (e.g. containing copper, magnesium, silicon, ferrous, lead, zinc, etc.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

For example, other color spaces than the HS(V) color circle could be used as well, such as RGB, IHS, CIE L*a*b*, CIE L*u*v*, YUV, YIQ, HSV, xy, rg, HSI, HLS, YCbCr, OHTA, LCH-uv, LCH-ab, etc.

Furthermore, multiple sensors and spectrometers can be combined by checking all requirements from all sensors before accepting a pixel and updating (e.g. sort to target color AND target material).

1. An apparatus for an automatic sorting machine, which apparatus allows the automatic sorting machine to sort matter to a target specification, the apparatus comprising:
a sensor device adapted to capture a reading of a matter passing the sensor device; and
at least one processing device configured to:
a) receive a first input of a first classifier defining an acceptable range of a property of the matter to meet said target specification;
b) receive a second input of at least one second classifier defining a possibly acceptable range of said property to meet said target specification;
c) detect said property of said matter based on said captured reading;
d) determine whether the detected property falls within the acceptable range of the first classifier, within the possibly acceptable range of the at least one second classifier, or outside the ranges of the first and second classifiers;
e) cause the matter to be accepted by the automatic sorting machine if the detected property falls within the acceptable range of the first classifier;
f) if the detected property falls within the possibly acceptable range of the at least one second classifier, cause the matter to be accepted by the automatic sorting machine if a current average of the property of sorted matter updated with the detected property falls within the acceptable range of the first classifier and cause the matter to be rejected by the automatic sorting machine if the current average of the property updated with the detected property falls outside the acceptable range of the first classifier; and
g) cause the matter to be rejected by the automatic sorting machine if the detected property falls outside the ranges of the first and second classifiers.

2. The apparatus according to claim 1, wherein the sensor device is adapted to capture a reading of matter passing the sensor device on a conveyor belt, on a chute, or free-falling, preferably at a speed of between 0.4 m/s-20 m/s.

3. The apparatus according to claim 1, wherein the sensor device is adapted to capture readings of a batch of matter passing the sensor device, and wherein the at least one processing device is configured to perform c) to g) for substantially each matter of said batch.

4. The apparatus according to claim 1, wherein the at least one processing device is configured to update the current average of the property of sorted matter with the detected property of the accepted matter.

5. The apparatus according to claim 3, wherein the at least one processing device is configured to update the current average of the property of sorted matter of the batch using vectors and the function:
$${v}_{b}^{′} = {v}_{b} + ( v - {v}_{b} ) r$$
wherein v′_{b} is the updated current average of the property, v_{b} is the current average of the property, v is the detected property of the accepted matter, and r is a rate in the range of 10⁻³⁰⁸ to 0.5

6. The apparatus according to claim 1, wherein the target specification includes a target mix of elements, and wherein the detected property includes the elemental composition of the matter.

7. The apparatus according to claim 6, wherein the second classifier comprises a fixed maximum acceptable contamination level or an adaptive acceptable contamination level for each element.

8. The apparatus according to claim 1, wherein the target specification includes a target color, and wherein the detected property includes the color of the matter.

9. The apparatus according to claim 8, wherein the at least one processing device is configured to express the detected color as coordinates in a color circle color space, and wherein the first and second classifiers are polygons in said color circle color space.

10. The apparatus according to claim 8, wherein the sensor device comprises a digital RGB camera adapted to take an image of the matter passing the digital RGB camera, and wherein the detected property is the color of at least one pixel of the matter in the image.

11. The apparatus according to claim 10, wherein the at least one processing device is configured to convert RGB values of said at least one pixel to said coordinates in the color circle color space using dot product operations.

12. The apparatus according to claim 8, wherein the sensor device comprises a visual spectrometer adapted to capture visual spectral data of the matter, and wherein the at least one processing device is configured to detect the color of the matter based on the captured visual spectral data.

13. The apparatus according to claim 1, wherein the at least one processing device is configured to detect an intensity of the matter based on the captured reading, cause the matter to be accepted by the automatic sorting machine if the detected property falls within the acceptable range of the first classifier and the detected intensity falls within a first predetermined acceptable intensity range, and cause the matter to be accepted by the automatic sorting machine if i) the detected property falls within the possibly acceptable range of the at least one second classifier, ii) the current average of the property updated with the detected property falls within the acceptable range of the first classifier, iii) the detected intensity falls within a second predetermined possibly acceptable intensity range, and iv) a current average of the intensity of the sorted matter updated with the detected intensity falls within the first predetermined acceptable intensity range.

14. The apparatus according to claim 13, wherein the first predetermined acceptable intensity range is a narrower sub-range of the second predetermined possibly acceptable intensity range.

15. The apparatus according to claim 1, wherein the target specification includes a target material type, wherein the sensor device comprises a spectrometer adapted to determine a spectrum of the matter passing the spectrometer, and wherein the detected property is material type of the matter.

16. The apparatus according to claim 8, wherein the target specification includes a target color and a target material type, wherein the first classifier defines an acceptable range of color of the matter to meet said target specification, wherein another first classifier defines an acceptable range of material type of the matter to meet said target specification, and wherein the at least one processing device is configured to cause the matter to be accepted by the automatic sorting machine if the detected color falls within the acceptable range of said first classifier and if the detected material type falls with the acceptable range of said another first classifier.

17. The apparatus according to claim 1, wherein the target specification includes a first property and a second, different property, wherein the first classifier defines an acceptable range of the first property of the matter to meet said target specification, wherein another first classifier defines an acceptable range of the second property of the matter to meet said target specification, wherein the at least one processing device is configured to detect said first and second properties of said matter based on said captured reading and optionally on at least one other reading of the matter captured by the sensor device, and to cause the matter to be accepted by the automatic sorting machine if the detected first property falls within the acceptable range of said first classifier and if the detected second property falls with the acceptable range of said another first classifier.

18. An automatic sorting machine adapted to sort matter to a target specification, the automatic sorting machine comprising:
an apparatus according to claim 1;
means for providing a stream of matter past the sensor device of said apparatus;
a container adapted to receive accepted matter from said stream; and
an ejector adapted to remove rejected matter from said stream before reaching said container.

19. The automatic sorting machine according to claim 18, wherein the means for providing a stream of matter past the sensor device comprises at least one of: a conveyor belt, a chute, and a free-falling arrangement.

20. The method for sorting matter to a target specification, the method comprising:
receiving a first input of a first classifier defining an acceptable range of a property of the matter to meet said target specification;
receiving a second input of at least one second classifier defining a possibly acceptable range of said property to meet said target specification;
capturing, by a sensor device, a reading of a matter passing the sensor device;
detecting said property of said matter based on said captured reading;
determining, by at least one processing device, whether the detected property falls within the acceptable range of the first classifier, within the possibly acceptable range of the at least one second classifier, or outside the ranges of the first and second classifiers;
causing the matter to be accepted by an automatic sorting machine if the detected property falls within the acceptable range of the first classifier;
if the detected property falls within the possibly acceptable range of the at least one second classifier, causing the matter to be accepted by the automatic sorting machine if a current average of the property of sorted matter updated with the detected property falls within the acceptable range of the first classifier and causing the matter to be rejected by the automatic sorting machine if the current average of the property updated with the detected property falls outside the acceptable range of the first classifier; and
causing the matter to be rejected by the automatic sorting machine if the detected property falls outside the ranges of the first and second classifiers.

21. The method according to claim 20, wherein the matter is or includes at least one plastic flake, such as PET flake, PE flake, PO flake, and/or PVC flake, or at least one metal flake, such as aluminum or an alloy thereof.

22. The method according to claim 20, wherein causing the matter to be accepted by the automatic sorting machine includes refraining from sending an ejection signal to an ejector of the automatic sorting machine for the matter, and wherein causing the matter to be rejected by the automatic sorting machine includes sending an ejection signal to the ejector for the matter.
